(19) United States
(12) Patent Application Publication
(10) Pub. No.: US 2010/0000390 A1
(43) Pub. Date: Jan. 7, 2010

(54) Linear movement length setting for rotary microtome

(76) Inventor: Reiner Fank, Rauenberg (DE)

Correspondence Address: KOHLER SCHMID MOEBUS, RUPPMANNSTRASSE 27, D-70565 STUTTGART, DE

(21) Appl. No.: 12/320,452

(22) Filed: Jan. 27, 2009

(30) Foreign Application Priority Data
Jul. 1, 2008 (DE) 10 2008 031 137.5

(51) Int. Cl. G01N 1/06

(52) U.S. Cl. 83/703

(57) ABSTRACT

The invention relates to a rotary microtome (1) with a vertically guided object carriage (2) and a drive mechanism that converts the rotary movement into the linear movement (8) of the object carriage (2). Such a rotary microtome should be constituted such that it can be used for specimens of different size categories. Means are inventively provided that are used to set the length of the linear movement that is caused by rotation of a drive.

The invention relates to a rotary microtome with a drive mechanism that converts a rotary movement into a linear movement for the object, wherein means are provided to set the length of the linear movement.

In microtome technology, two main types of microtomes are particularly widespread. For the quality of the cuts, it is necessary for the knife to be guided through the specimen without shaking, the beginning of the cut being especially critical. This problem is therefore also frequently solved on conventional carriage microtomes with a pulling cut, wherein the knife is not completely perpendicular to the direction of movement of the knife carriage. The quality of the cuts is decisive for their usefulness because even minor impairments to the tissue (folding, stretching, tearing) prevent reliable assessment.

Conventional carriage microtomes are characterized by their simple design (horizontally guided knife carriage moves across object holder) and their resulting low price. They permit greater flexibility in use of knife blades as the entire width of the knife can be used, since it is only clamped on one side. This is advantageous for pulling cuts. Experienced personnel can produce just as high-quality cuts with this microtome as with rotary microtomes.

For larger scale use, in particular, for serial cuts, rotary microtomes are generally preferred because it is possible to work very much faster with them. Known rotary microtomes, for example, the HM 340 E of the Assignee, comprise a knife holder disposed on a base plate (usually horizontally) and a guided object carriage disposed perpendicular thereto (e.g. vertically), which is actuated with a drive mechanism that converts the rotary movement into linear movement, for example, by means of a crank that engages in a sliding link guide. This can be either manual or motor-driven. Weights may be provided to compensate for the imbalance caused by the weight of the carriage during the downward movement. The greater working speed of this type of microtome is due to that fact that it has a much shorter linear movement than the carriage microtome and can therefore achieve a shorter cutting cycle.

A further advantage of rotary microtomes is that their cut quality is much less dependent on the skill of the operator because, due to the one-sided driving direction of the crank drive, the cutting movement of the rotary microtome is very much more even than the alternating operation of the carriage microtome, without requiring any special practice. For optimization of the cutting speed and cutting precision, an appropriate size ratio must be found between the linear movement length and the specimen size. Unnecessary traversing distances cost time and entail a risk of the carriage starting to oscillate, which can result in impairment of the quality of the cuts produced (folding, stretching, tearing).

The specimens to be cut are usually embedded in materials suitable for cutting in cassettes of standards sizes. The necessary size of the cassette results from the size of the materials and is usually in the mm range up to just under the cm range.

This results in a need to optimize the production of rotary microtomes for a certain size range of specimens. This has the disadvantage that in laboratories, in which specimens of different size categories are to be cut, multiple microtomes may be needed for the various size categories required, or cuts have to be made in certain size categories that are less than optimal because they either exhibit impaired cut quality or have to be effected with a relatively time-consuming, unnecessarily large linear movement.

DE 2 253 628 A discloses a rotary microtome of the type stated above that comprises a rocker lever drive. In this microtome, the object is carried on the end of the specimen holder arm constituted as a rocker lever that is supported by means of an axle located at the other end in such a way that the object can be moved up and down on a circular arc for the cut. Driving is performed via further levers, driven by a rotating eccentric. The eccentricity thereof can be adjusted using two eccentric disks, one disposed within the other and rotatable relative to one another, which changes the linear movement.

DE 2 246 851 A also discloses a microtome with a rocker lever drive, wherein the rocker lever can be implemented via a crank drive or also via a rotating eccentric. The linear movement may be transmitted from the rocker lever to the object through a transmission lever attached to the rocker lever by an articulated joint, which, however, is not specifically disclosed. Adjustment of the linear movement is effected by changing the effective lever length of the rocker lever. Herein, either the bearing of the transmission lever on the rocker lever is shifted or the center of rotation of the rocker lever itself is shifted on the rocker lever.

Rotary microtomes with such rocker lever drives have, however, not become common in practice. Today's rotary microtomes usually comprise an object sliding link guided by means of a vertical guide and driven by means of a crank drive that directly performs the linear movement of the object carriage.

However, it is not possible to implement the suggestions stated above for setting the length of the linear movements on rocker lever drives of these devices.

The object of the invention is therefore to equip a rotary microtome of the type stated above with means for setting the length of the linear movement so that it can be used for specimens of different size categories.

This is achieved on a rotary microtome of the type stated above by locating the object on an object carriage that is guided vertically in an object sliding link guide, by having the drive mechanism convert the rotary movement into the linear movement of the object carriage by the fact that it comprises a crank drive with a crank, crankpin, crankshaft, and a crankpin engagement in a guide in the object carriage, and that the means are constituted as a way of setting the distance of the crankpin from the centerline of the crankshaft.

This has the advantage of simple mechanical design, in particular, of the adjustment of the length of the linear movement without assembly work.

In alternative embodiments, the setting can be made either in steps or continuously. Setting in steps has the advantage of simpler implementation and reliable operation while continuous setting has the advantage of more flexible settability even for special sizes or other special requirements.

In an advantageous further embodiment of the setting facility, the means for setting the length of the linear movement comprise an adjustment base for the crankpin that is adjustably disposed in the crank and means for operating this. Such an adjustment base could be disposed such that it can be shifted or rotated.

In a convenient embodiment, the means for operation comprise an engagement possibility in the adjustment base that is disposed on the side opposite the crankpin and an adjustment tool for engaging therein. This has the advantage that adjustment of the crankpin using a tool is possible from outside the crankshaft housing.

In an expedient embodiment, this is constituted as a rotary movement and the pivot pin is eccentrically disposed on the adjustment base. This has the advantage that production of the linear movement can be effected by a simple rotary movement of the adjustment base so that this is possible by introducing a tool through an opening in the housing.

In a convenient embodiment, the adjustment base is constituted with a cone and the crank with a corresponding reception element. This has the advantage that backlash can be eliminated. It is most convenient if the conicity is 5-6° larger than the self-locking value, in order to achieve optimum elimination of backlash.

In a further embodiment, the adjustment base comprises an annular slot and flat springs that can be attached to the crank for engagement in this annular slot. This has the advantage that the adjustment base can be kept free of backlash by the spring compression and, in particular, is pressed into the reception cone of the crank.

In a further embodiment with adjustment in steps, the annular slot comprises one or more latching notches and the flat springs are constituted with a latching lug, wherein the flat springs are disposed on the crank in such a way that the latch engagements correspond to defined settings of the linear movement length. This has the advantage that the linear movement length can be set with reliable allocation and precisely for various object sizes.

In a convenient example of the embodiment stated above, two latching notches are disposed at 180° with respect to one another and two flat springs are disposed with their latching lugs for engagement in these latching notches. This permits two-step settability of the setting of the length of linear movement.

In an alternative embodiment for continuous setting and the means therefor, the adjustment base is constituted as a wormwheel on which the crankpin is eccentrically disposed and an engagement possibility for an adjustment tool is provided in a worm that interacts with the wormwheel during operation. This has the advantage that self-locking of the means is provided that permits continuous settability without the need for latching.

In all the embodiments stated above, expedient means are provided to engage and release the crankshaft by means of which the crankshaft and/or the crank can be latched in such a way that the adjustment tool can engage with the engagement facility on the adjustment base or on the worm, wherein the engagement is constituted in such a way that it can be released. This permits easy and reliable operability by enabling reliable location of the engagement position for making the setting, in particular, if an adjustment tool is to be passed through an opening of the microtome housing, and reliable setting is permitted by blocking the crankshaft.

In an advantageous embodiment, a latching rod is provided for this purpose that can be guided through an opening in the crankshaft housing to the crankshaft to engage the latter, and with an engagement opening for the latching rod in the crankshaft in which the latching rod can engage if the crankshaft is in the position for engagement of the adjustment tool. This has the advantage that latching the crankshaft in the defined position can be simply performed from outside.

In an advantageous further embodiment of the latching rod, a position pin is disposed laterally on the latching rod, a shiftable and rotatable bearing of the latching rod is disposed in an opening constituted as a drill-hole, a recess for the position pin is disposed on the edge of the drill-hole, wherein the edge holds the latching rod in the released position by means of the position pin and, during engagement of the position pin in the recess, the latching rod can be shifted into the engagement opening, with an annular collar being disposed on the latching rod, wherein a spring surrounds the latching rod and is disposed such that the force of the spring acts on the collar of the latching rod and the latter therefore engages in the engagement opening of the crankshaft. This has the advantage that the latching rod can remain permanently on the device and nevertheless unintentional latching can be reliably prevented by ensuring that latching is only possible when the latching rod has first been put into the latching position. During deployment of the latching rod, that is, when the positioning pin is in the recess, the spring causes the latching rod to automatically move during rotation of the crankshaft into the correct position through its spring force.

In an advantageous embodiment, balancing means are provided to compensate for imbalance in the drive mechanism. This ensures smooth running of the drive mechanism.

These means can, for example, be provided on the drive wheel.

In a convenient further embodiment, these means are constituted such that they can be adjusted to adapt them to the length of linear movement that is currently set.

In a possible embodiment of the adjustable balancing means, a first adjustable balancing weight is combined with a second, permanently fixed balancing weight. This means that only part of the mass has to be moved for adjustment.

In one possible embodiment, the settability is constituted by means for changing the radial position of the adjustable balancing weight with respect to the crankshaft. This has the advantage that the adjustability can be implemented both in steps, for example, by latching, and continuously.

In a convenient embodiment of the balancing means, the first balancing weight is permanently disposed in the drive wheel and the second balancing weight is disposed in the drive wheel such that it can be removed. This has the advantage that allocation to certain lengths of linear movement is defined and adjustment is not necessary, wherein only part of the weight has to be moved.

It is possible for the removable nature of the second balancing weight to be achieved by displacement from an active position in the drive wheel into an idle position in the microtome housing and constituted such that it can be retrieved from this position into the active position. This has the advantage that the balancing weight can simply be moved back and forth between an idle and a deployed position.

An embodiment of the second balancing weight can be such that it comprises at least two continuous openings one for each retaining pin in the drive wheel, and an opening for a push rod by means of which the second balancing weight can be moved from the active position into the idle position. This has the advantage of simple handling by the user.

It is also possible for the idle position to be constituted by two corresponding retaining pins within the microtome housing, and in such a way that moving the second balancing weight from the retaining pins in the active position onto the retaining pins in the idle position can be effected by sliding. This facilitates handling by the user.

It is expedient for the second balancing weight to be held in its active position in the drive wheel by a latching facility. This has the advantage that a change in position of the adjustable balancing weight can be reliably avoided.

The latching facility can, for example, be constituted in such a way that the second balancing weight comprises, over at least one retaining pin opening, at least one ball thrust element, comprising a ball and spring and the retaining pin in the drive wheel is equipped with an annular slot, into which the ball engages in the required final position of the active position.

In one embodiment, the engagement opening for the push rod and the push rod itself comprise mating elements, by which the push rod can be secured in the adjustable balancing weight. This has the advantage of reliable and controlled operation of the adjustable balancing weight, in particular, when pulling back the weight out of the microtome housing and into the drive wheel by means of a tool acting from the outside.

For example, the means may comprise threads that are disposed in the engagement opening for the thrust rod and on the front end of the push rod so that the push rod can be screwed into this to pull back the balancing weight.

The invention is explained using embodiments shown in the drawing and reference is made to alternative design possibilities. The figures show the following

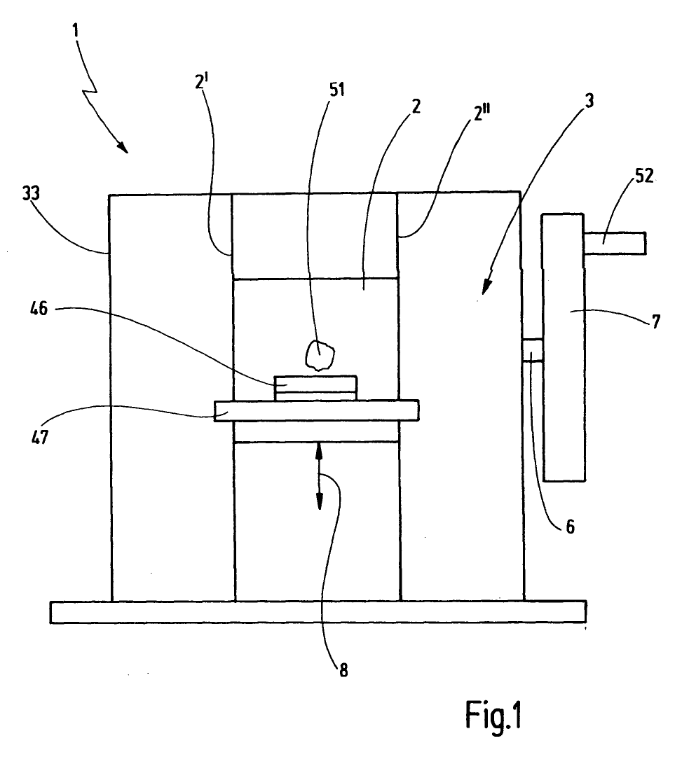

FIG. 1 a sketch of the working principle of a conventional rotary microtome

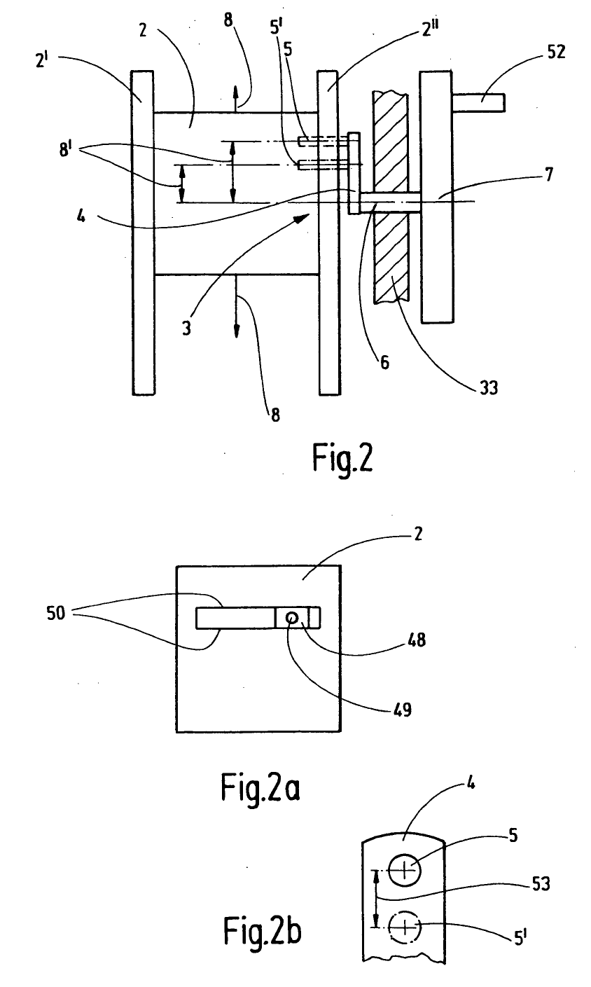

FIG. 2 a schematic representation of the object carriage drive with an inventive embodiment

FIG. 2a the sliding link guide of the object carriage in detail

FIG. 2b a schematic representation of the crank inventively constituted for adjustability

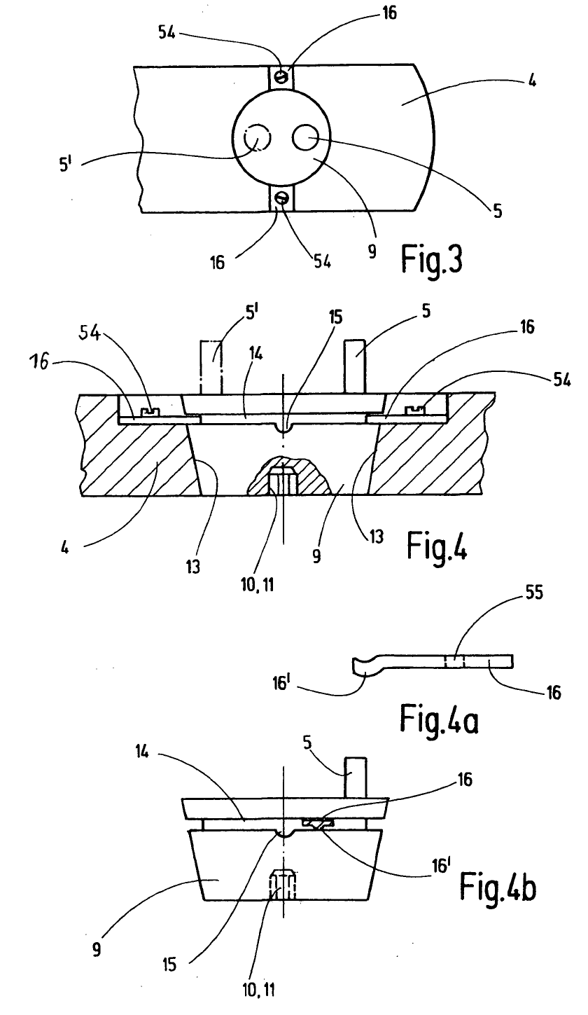

FIG. 3 a crank with a rotatable adjustment base

FIG. 4 a crank according to FIG. 3 with an adjustment base in cross-section

FIG. 4a a flat spring as a detail for FIG. 4

FIG. 4b the working principle of the latch with flat spring and adjustment base from FIG. 4 in detail

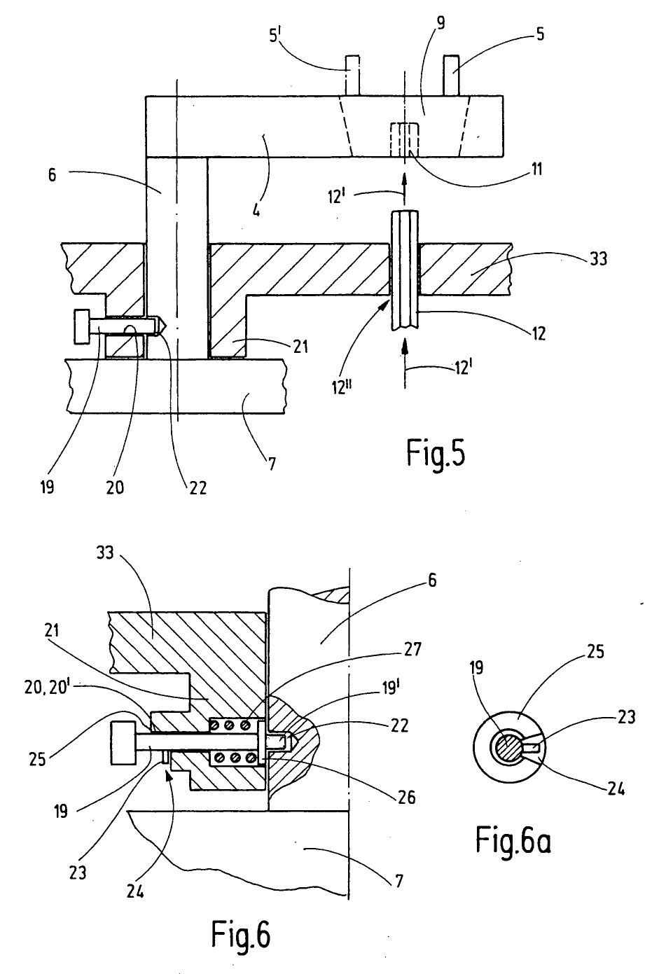

FIG. 5 a schematic representation of the working principle both of the engagement of the adjustment tool on the adjustment base and of the engagement of a latching rod into the crankshaft for securing it

FIG. 6 a specific embodiment of the latching rod

FIG. 6a a detail of FIG. 6 with positioning pin engagement

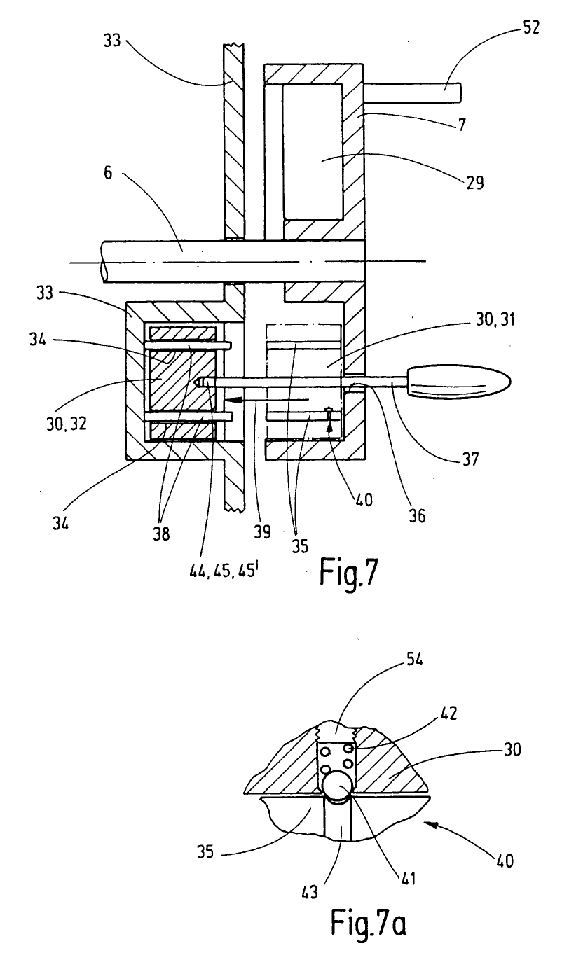

FIG. 7 a schematic representation of the working principle of a two-part balancing weight

FIG. 7a a latch lock as a detail for FIG. 7

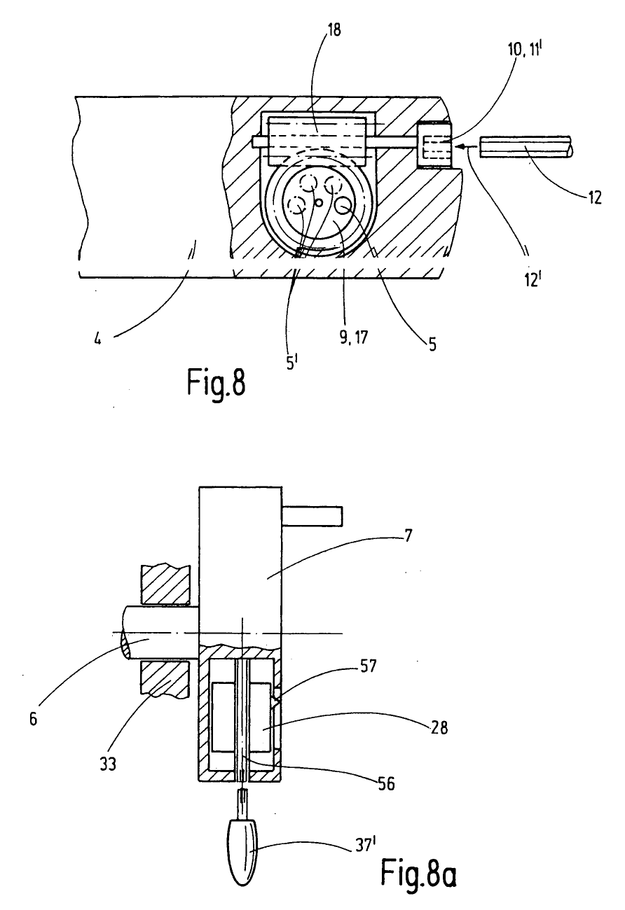

FIG. 8 a schematic representation of the embodiment of a continuous adjustability of the linear movement

FIG. 8a a continuously adjustable balancing weight

FIG. 1 schematically shows of the working principle of a conventional rotary microtome 1. The microtome has an object carriage 2 that is vertically guided in a microtome housing 33 by means of an object sliding link guide 2′, 2″. The object carriage 2 interacts with a knife 46 that is held in a knife holder 47 in such a way that the object 51 disposed on the object carriage 2 is cut. For this purpose, the object carriage executes an up and down movement that is indicated by the double arrow 8. To generate this linear movement 8, a drive is used that, for example, can be effected by means of a drive wheel 7 and a handcrank 52. The linear movement distance 8 that is traversed as the cutting movement requires an appropriate drive mechanism that is generally constituted as a crank drive 3, of which only the crankshaft 6 is visible here however.

FIG. 2 shows a schematic representation of the object carriage drive with the inventive further embodiment. The nature of the invention is that the crank drive 3 is constituted such that means are provided by which the length of the linear movement 8 can be set. In a crank drive 3 this can be effected by the crankpin 5, 5′ on a crank 4 being settable in its radial distance from the crankshaft 6. This is indicated by the fact that the crankpin can adopt an outer position 5 or a further inward located position 5′. The linear movement distance indicated by the double arrow 8 changes in accordance with this change in the position of the crankpin 5, 5′, wherein the linear movement distance 8 corresponds to twice the distance of the crankpin 5 or 5′ from the centerline of the crankshaft 6. This is drawn in by a double arrow as half linear movements 8′. Of course, the crankpin 5 can also be constituted so as to be adjustable in a multiplicity of positions or continuously adjustable.

In this, as in all the following figures, the same reference symbols indicate elements with the same functions and are therefore not always described for each figure.

FIG. 2a shows a sliding link guide 50 of the object carriage 2. This sliding link guide 50 is used to transmit the rotary movement of the crankpin 5, 5′ to the object carriage 2, wherein this rotary movement is converted to the said vertical movement. This is performed by means of the sliding link block 48 that can be slid in the sliding link guide 50 and comprises a crankpin engagement 49, in which the crankpin 5 engages according to FIG. 2. This is, of course, only an example of conversion of a rotary movement to a linear movement, other possibilities, such as elongated hole guides, etc. are known.

FIG. 2b shows a schematic representation of the crank 4 with the inventive embodiment for adjustability of the crankpin 5, 5′. The double arrow 53 shows the adjustment of the crankpin 5 into another position, such as position 5′. Such an adjustment could, for example, be performed with a sliding link block guide, wherein a spindle adjustment of the sliding link block would be possible. A further possibility is a rotatable adjustment base that is explained in more detail below.

One example of such a crank 4 with a rotatable adjustment base 9 is shown in FIG. 3. The rotatable adjustment base 9 is recessed into the crank 4 and is kept as free as possible of backlash there. For this purpose, flat springs 16 are provided that engage in an annular slot 14 of the adjustment base 9. The flat springs 16 are attached by means of screws 54. Depending on the rotation of the adjustment base 9, the crankpin 5 can be put in the position marked with a continuous line or the dot-and-dash-lined position 5′ or in an intermediate position and the object slide 2 executes a linear movement 8.

FIG. 4 shows a crank according to FIG. 3 with further details. It can be seen how the adjustment base 9 is pressed into a conical shape 13 by means of the spring force exerted by the flat springs 16. Both the adjustment base 9 and correspondingly its bearings in crank 4 have this conical shape 13. In this way, the adjustment base 9 is held in bearings in crank 4 without backlash. This lack of backlash is better, the steeper the matching conical surfaces are, and the angle must, of course, be chosen appropriately for the material so that self-locking does not occur.

The figure also shows a latching notch 15, wherein in accordance with the flat springs 16 offset by 180° these latching notches 15 are also offset by 180°, so that the latching recesses 16′ (see FIGS. 4a and b) of the two flat springs 16 engage in the corresponding position of the adjustment base 9 into the latching notches 15. In this way, the adjustment base 9 latches every half revolution, so that the two positions 5 and 5′ of the crankpin 5, 5′ can be achieved. In such an embodiment, two different lengths of linear movement 8 can thus be set. Alternatively, of course, multiple positions can be set or a continuous setting is possible if the adjustment base 9 is latched into its setting in a different way, for example, by a mechanism that presses it into the cone 13 of the crank 4. The setting movement itself is actuated by an operating means 10, that is depicted here as engagement possibility 11 for an adjustment tool 12. This is described further below.

FIG. 4a shows a flat spring 16 in detail, wherein the latching lug 16′ is visible as a bent portion, and a drill-hole 55 for the fixture with a screw 54.

FIG. 4b shows the working principle of latching of the adjustment base 9 mentioned above, wherein it can be seen how the front end of the flat spring 16 with the latching lug 16′ runs in the annular slot 14 until the latching lug 16′ engages in the latching notch 15. The same also occurs on the rear.

FIG. 5 shows a schematic representation of the working principle of the engagement 11 of the adjustment tool 12 on the adjustment base 9 and of the engagement of a latching rod 19 into the crankshaft 6 to secure the latter for the said engagement of the adjustment tool 12.

This function is as follows: Before the latching rod 19 engages in the engagement opening 22 of the crankshaft 6, the crankshaft 6 must be turned with the crank 4 until the engagement opening 22 of the crankshaft 6 is exactly aligned with an opening 20 in the crankshaft housing 21. Then the latching rod 19 held in the opening 20 can be pushed into this engagement opening 22, and the crankshaft 6 with the crank 4 is latched precisely in the position, at which the adjustment tool 12 can be introduced into the engagement facility 11 of the adjustment base 9 toward the arrow 12′. Now it is possible to rotate the adjustment base 9 until the crankpin enters the desired position 5 or 5′. This exact positioning is necessary because the crank 4 is located inside the microtome housing 33 and the introduction opening 12″ in the microtome housing 33 must be precisely aligned with the engagement facility 11 of the adjustment base 9 for introduction 12′ of the adjustment tool 12. The figure also shows the disposition of the drive wheel 7, with which the crankshaft 6 is rotated.

So that in the case of such a rotation of the drive wheel 7, the latching rod 19 automatically slides into the engagement opening 22 of the crankshaft 6 for the latching, it is possible to provide the mechanism suggested in FIGS. 6 and 6a or a mechanism with an identical function. The opening 20 constituted as a drill-hole 20′ for bearing the latching rod 19 is located in the crankshaft housing 21 protruding from the microtome housing 33. This has a collar 26 that is disposed behind an engagement pin 19′ of the latching rod 19. The engagement pin 19′ is used for engagement in the engagement opening 22 of the crankshaft 6. In the crankshaft housing 21, spring 27 is held that acts on the collar 26 and thus presses the engagement pin 19′ toward the crankshaft 6. In this way, it is possible, if the engagement pin 19′ is not in the engagement opening 22, for the crankshaft 6 to be turned with the drive wheel 7 until the engagement pin 19′ is aligned with the engagement opening 22 and is thus pushed by means of the spring 27 into the engagement opening 22. Then the crankshaft 6 is in the engagement position described above for use of the adjustment tool 12.

To be able to put the latching rod 19 permanently out of engagement for normal operation of the microtome, a position pin 23 is disposed on the latching rod 19 that can be turned upward to rest against edge 25, if the latching rod 19 is pulled out and turned against the force of the spring 27. If, on the other hand, the latching rod 19 is to be put in the said engagement position, it is turned until the position pin 23 slides into a recess 24 on the edge 25 such that the spring 27 can push the engagement pin 19′ into the engagement opening 22 of the crankshaft 6, as soon as the latter reaches the corresponding position due to the rotation of the crankshaft 6. FIG. 6a shows a view of the latching rod 19 from the left, wherein for better visibility of edge 25, position pin 23, and recess 24, the head of the latching rod 19 is cut off.

FIG. 7 shows a schematic representation of the working principle of a two-part balancing weight 29, 30. This representation shows the drive wheel 7 with the crankshaft 6 that engages in the microtome housing 33. For simplification, the crankshaft housing 21 with the latching rod 19 has been omitted.

As in the case of the known microtomes with a crank drive, a balancing weight 29 is permanently disposed in the drive wheel 7 that is used to avoid unbalances in the rotary movement that primarily result from the object slide 2 executing upward and downward movements.

If the length of linear movement 8 is changed, another balancing weight is required to compensate for the imbalance. One way of doing this is to provide, together with the permanent first balancing weight 29, a second removable balancing weight 30 whose weight is dimensioned appropriately for setting of linear movement length 8. Such a second balancing weight 30 with a certain mass is sufficient if only two different positions of the crankpin 5, 5′ are to be set. It is then possible to compensate for the difference between these two linear movement lengths either by holding the second balancing weight 30 in an active position 31 in the drive wheel 7 or by putting it in an idle position 32 outside the drive wheel 7.

In the simplest case, this second balancing weight 30 could simply be removed from the drive wheel 7. Preferably, this removable second balancing weight 30 is, however, constituted in such a way that it can be shifted from an active position 31 in the drive wheel 7 into an idle position 32 in the microtome housing 33. For this purpose, it is held in such a way that it can be shifted and a facility must be provided to effect this shift. One possibility is an opening 36 in the drive wheel 7 that is for introduction of a push rod 37 with which the second balancing weight 30 can be pushed into a reception element of the microtome housing 33.

To effect this, the balancing weight 30 must have two openings 34 as through-holes into which both retaining pins 35 in the drive wheel 7 and corresponding retaining pins 38 can engage in the microtome housing, wherein the balancing weight 30 can then slide from one retaining pin 35 or 38 to the other retaining pin 38 or 35 over the displacement distance 39. To enable this shift, the retaining pins 35 and 38 must be aligned if the drive wheel 7 is in the latched position already stated above.

So that it is possible not only to cause the shift from the active position 31 into the idle position 32 with the push rod 37 but also the reverse shift, an engagement opening 44 for the push rod 37 in the balancing weight 30 must be provided by means of which the balancing weight 30 can also be pulled back from the idle position 32 into the active position 31. Most conveniently, threads 45 and 45′ in the engagement opening 44 and correspondingly at the end of the push rod 37 must be provided so that the latter can be screwed in.

In the drive wheel 40, for example, on one of the retaining pins 35, a latch mechanism 40 can be provided that can prevent the balancing weight 30 from moving out of its position when the drive wheel 7 is operated.

Such a latch mechanism 40 can, for example, comprise a ball 41 on which spring force is exerted by a spring 42 and in this way engages in an annular slot 43 of the retaining pin 35 in such a way that it can be unlatched again by applying a certain force. To be able to introduce the ball 41 into a corresponding drill-hole of the balancing weight 30, which must be so narrow at the front end that the ball 41 is held such that is protrudes, a screw 54 is expediently provided that presses the spring 42 against the ball 41 in such a way that the latter protrudes far enough to latch.

FIG. 8 shows a schematic representation of an embodiment of continuous adjustability of the linear movement length 8 of a rotary microtome 1. Sometimes there may be a need to make such a linear movement length 8 continuously settable to process tissue specimens of very varied sizes while avoiding being limited to two or a limited number of linear movement lengths. For this purpose, it is possible to constitute the inventive mechanism such that a crankpin can be put in different positions 5′ continuously without steps.

One example of such an embodiment is that the adjustment base 9 can be moved into different rotary positions. This can be implemented very expediently if the adjustment base 9 is a wormwheel 17 that can be rotated by a worm 18. This has the special advantage that the worm 18 causes self-locking of the wormwheel 17 so that any position of a crankpin 5, 5′ can be set without it being possible for such a setting to be entered unintentionally. In the case of this drive mechanism, an introduction opening 12′ for an adjustment tool 12 must be provided such that, by means of the adjustment tool 12, the worm 18 can be rotated. In this case, too, as described above in FIG. 5, the crank 4 can be held in the corresponding position by a latching facility in which the adjustment tool 12 can be introduced through an introduction opening 12″ through the microtome housing 33 in such a way that it can engage in the engagement possibility 11′ of the worm 18.

FIG. 8a shows a continuously adjustable balancing weight 28, which is then needed if the linear movement length 8 can be continuously set, as described for FIG. 8. For example, the adjustable balancing weight 28 may be disposed in the drive wheel 7 in the radial direction in such a way that it can be shifted so that it can be positioned at different distances from the crankshaft 6. A threaded spindle 56 is favorably provided for this purpose that is held in such a way that it can rotate in the adjustable balancing weight 28 that is fitted with a mating thread. This threaded spindle 56 can be driven with an adjustment tool 37′ so that the balancing weight 28 seen radially can be put into different positions in the drive wheel.

It is also possible to provide a setting display 57 to see this position from outside. The latter is conveniently and best equipped with a scale if the mechanism according to FIG. 8 has a similar display and in this way it is also possible to assign a certain setting of the balancing weight 28 to a certain set linear movement length 8. The adjustable balancing weight 28 can be combined with a permanently installed balancing weight so that a smaller mass has to be moved.

These embodiments are, of course, only exemplary. For example, it would be possible to adjust the crankpin 5, 5′ by making the crank 4 adjustable in length or it may be expedient to link the setting of the crankpin 5, 5′ with a setting of a balancing weight 28 mechanically so that both settings can be made simultaneously and attuned to one another.

Of course, this setting option is also possible for a rotary microtome 1 with an electric drive or it is possible for the mechanical settings to be made electrically, for example, by means of stepper motors, that could drive a worm 18, for example, and correspondingly also the threaded spindle 56 for setting the balancing weight 28. Further embodiments can be envisaged.

### LIST OF REFERENCES

1 Rotary microtome

2 Object carriage (vertically guided)

2′, 2″ Object sliding link guide 5

3 Crank drive

4 Crank

5 Crankpin (1^{st} position)

5′ Crankpin 2^{nd} position

6 Crankshaft

7 Drive wheel

8 Double arrow: Linear movement length (vertical)

8′ Half linear movement length

9 Adjustment base

10 Operating means for adjustment base 15

11 Engagement possibility (adjustment base)

11′ Engagement possibility (worm)

12 Adjustment tool

12′ Arrow: Introduction for adjustment tool

12″ Introduction opening 20

13 Cone

14 Annular slot

15 Latching notch

16 Flat spring

16′ Latching lug

17 Wormwheel

18 Worm

19 Latching rod

19′ Engagement pin of the latching rod

20 Opening

20′ Drill-hole

21 Crankshaft housing

22 Engagement opening for latching rod

23 Position pin

24 Recess for position pin (engagement position)

25 Edge

26 Collar

27 Spring

28 Balancing weight (adjustable)

29 First balancing weight (permanent)

30 Balancing weight (removable)

31 Active position

32 Idle position

33 Microtome housing

34 Opening for retaining pin (retaining pin opening)

35 Retaining pins active position

36 Opening for push rod

37 Push rod

37′ Setting tool

38 Retaining pins idle position

39 Arrow: Push distance

40 Latching facility

41 Ball

42 Spring

43 Annular slot (retaining rod)

44 Engagement opening for push rod

45, 45′ Thread (engagement opening and push rod)

46 Knife

47 Knife holder

48 Sliding link block

49 Crankpin engagement

50 Sliding link block guide

51 Object

52 Handcrank

53 Double arrow: Adjustment of the crankpin

54 Screws

55 Drill-hole

56 Thread spindle

57 Setting display

1-27. (canceled)

28. A rotary microtome with a drive mechanism that converts a rotary movement into a linear movement for processing an object, the microtome comprising:
a crank drive having a crankshaft, a crank cooperating with said crankshaft, and a crankpin cooperating with said crank;
an object carriage on which the object is disposed, said object carriage defining a guide having a crankpin engagement cooperating with said crankpin;
an object sliding link guide in which said object slide is vertically guided, thereby converting a rotary movement of said crank drive into a linear movement of said object slide; and
means for setting a distance of said crankpin from a centerline of said crankshaft to thereby define a length of linear displacement of said object carriage.

29. The rotary microtome of claim 28, wherein said distance can be set in steps.

30. The rotary microtome of claim 28, wherein said distance can be set continuously.

31. The rotary microtome of claim 28, wherein said distance setting means comprise an adjustment base disposed in said crank, said adjustment base cooperating with said crankpin and further comprising means for operating said adjustment base in an adjustable manner.

32. The rotary microtome of claim 31, wherein said adjustment base operating means comprise an engagement facility on said adjustment base that is disposed on a side opposite said crankpin and an adjustment tool for engagement in said engagement facility.

33. The rotary microtome of claim 32, wherein said adjustment base is adjusted by rotary movement and said crankpin is disposed eccentrically on said adjustment base.

34. The rotary of claim 33, wherein said adjustment base has a conical shape and said crank defines a corresponding conical recess.

35. The rotary microtome of claim 33, wherein said adjustment base is anchored in said crank via an annular slot and flat springs that can be fixed on said crank for engagement in said annular slot.

36. The rotary microtome of claim 35, wherein said annular slot has one or more latching notches and said flat springs are equipped with a latching lug, wherein said flat springs are disposed on said crank such that a latching notch engagements correspond to a defined setting of a length of linear movement.

37. The rotary of claim 36, wherein two latching notches are disposed at 180° with respect to one another and two flat springs are disposed with latching lugs for engagement in said latching notches.

38. The rotary of claim 31, wherein said adjustment base is constituted as a wormwheel on which said crankpin is eccentrically disposed and said means for operating said adjustment base comprise an engagement for an adjustment tool in a worm that interacts with said wormwheel for rotation thereof.

39. The rotary microtome of claim 28, further comprising means for securing and releasing said crankshaft such that said crankshaft or said crank are latched to permit an adjustment tool to engage with an engagement facility on an adjustment base or on a worm in a releasable manner.

40. The rotary microtome of claim 39, wherein said crankshaft securing and releasing means comprise a latching rod that can be guided through an opening in a crankshaft housing to engage and secure said crankshaft, and a side engagement opening for said latching rod defined in said crankshaft, wherein said latching rod engages said engagement opening when said crankshaft is disposed in a position for engagement of said adjustment tool.

41. The rotary microtome of claim 40, wherein said means for securing and releasing said crankshaft comprise a position pin that is disposed laterally on said latching rod, a shiftable and rotatable bearing of said latching rod in an opening constituted as a drill-hole, and a recess for said position pin in an edge of said drill-hole, wherein said edge holds said latching rod in a release position by means of said position pin and, during engagement of said position pin in said recess, said latching rod can be pushed into said side engagement opening, and with an annular collar disposed on said latching rod as well as a spring surrounding said latching rod and cooperating with said annular collar for urging said latching rod into said side engagement opening of said crankshaft.

42. The rotary microtome of claim 28, further comprising balancing means to compensate for imbalance of a drive mechanism.

43. The rotary microtome of claim 42, wherein said balancing means are disposed in a drive wheel of said crank drive.

44. The rotary microtome of claim 43, wherein said balancing means are adjustable.

45. The rotary microtome of claim 44, wherein said adjustable balancing means comprise a first, permanently positioned balancing weight and a second adjustable balancing weight.

46. The rotary microtome of claim 45, wherein adjustability is effected by means for changing a radial position of said second adjustable balancing weight with respect to said crankshaft.

47. The rotary microtome of claim 46, wherein said first balancing weight is disposed permanently in said drive wheel and said second balancing weight is disposed in said drive wheel such that it can be removed.

48. The rotary microtome of claim 47, wherein removal of said second balancing weight is effected by shifting said second balancing weight from an active position in said drive wheel into an idle position in a microtome housing, wherein said second balancing weight can be returned from said idle position to said active position.

49. The rotary microtome of claim 48, wherein said second balancing weight has at least two through-holes, one for each of two active retaining pins disposed in said drive wheel, said drive wheel having an opening for a push rod, wherein said push rod displaces said second balancing weight from said active position into said idle position.

50. The rotary microtome of claim 49, wherein said idle position is defined by two idle retaining pins within said microtome housing such that said shifting of said second balancing weight is effected by sliding from said active retaining pins in said active position to said idle retaining pins in said idle position.

51. The rotary microtome of claim 50, wherein said second balancing weight is held in said active position in said drive wheel by a latching facility.

52. The rotary microtome of claim 51, wherein said latching facility comprises at least one ball thrust element disposed in said second balancing weight proximate at least one retaining pin opening, said ball thrust element comprising a ball and spring, wherein one of said active retaining pins in said drive wheel has an annular slot in which said ball engages at a desired active position of said second balancing weight.

53. The rotary microtome of claim 52, wherein said second balancing weight has an engagement opening for said push rod and said push rod comprises mating elements by which said push rod can be secured in said second balancing weight.

54. The rotary microtome of claim 53, wherein said engagement opening comprises threads for said push rod, which engage with threads disposed on an front end of said push rod.
